(19) United States
(12) Patent Application Publication
(10) Pub. No.: US 2008/0034661 A1
(43) Pub. Date: Feb. 14, 2008

(54) Shutter system with merging-registering graphics

(76) Inventors: John C. Halter, Addison, TX (US); Alan Oppenheimeer, Plano, TX (US)

Correspondence Address: John E. Vandigriff, 906 Stone Circle Ln, Lewisville, TX, 75056, US

(21) Appl. No.: 11/500,353

(22) Filed: Aug. 8, 2006

(51) Int. Cl. E06B 7/02

(52) U.S. Cl. 49/39

(57) ABSTRACT

A shutter device for covering windows; which incorporates two panels. Each panel has clear and printed areas which are digitized with an image. When the shutters are moved in the open position, the images merge and the images of the two shutters appear back to back. When the shutters are moved in the opposite direction closed, the image from both shutters is visible. In addition to providing aesthetic appeal of the merging image, the shutter provides and blocks vision though the shutter as one panel is moved with respect to the other. The shutter device is adaptable to semicircular, circular and rectangular windows. The shutter utilizes two panels mounted on the inside of a frame; one of the panels is moveable. The panels are of a clear material, such as glass or plastic, each panel has alternate clear and printed areas. When the two panels are aligned so that clear areas are adjacent (open position), there is viewing through the window and the digitized image of the first and second panel are viewed one behind the other. When a printed area is aligned over a clear area, vision through the shutter (closed position) is blocked and the digitized image can be viewed.

### FIELD OF THE INVENTION

The invention relates to window shutters and coverings, and more particularly to a window covering including two parts, each part having clear and printed regions that are digitized with an image.

### BACKGROUND OF THE INVENTION

In U.S. Pat. No. 5,823,241, a window blind has horizontal slats cut to fit into a semicircular window.

In U.S. Pat. No. 5,662,153, a frame supports a fan-shaped pleated shade that is rotated from a folded open position to an unfolded closed position to that the shade covers a semicircular wind adjacent to the shade.

The above patents show examples of shutter apparatus for opening and closing semicircular windows, but are described only for purposed of showing examples of prior art for semicircular window shutters.

### SUMMARY OF THE INVENTION

The invention is a shutter device for covering windows and providing a means for “opening” and “closing” the shutter. Each part having clear and printed regions that are digitized with at least one image. The digitized shutter image may be translucent and backlit with natural or artificial light. The digitized image(s) block vision through the shutter. These images merge together when in the open position, and when in the closed position the images become registered and are fully displayed. When in the closed position, the view through the shutter is blocked and in the open position, view through the shutter is possible.

The shutter device is adaptable to semicircular, circular and rectangular windows. The shutter utilizes two panels of clear material, such as glass or plastic each panel has alternate clear and printed areas. When the two panels are aligned so that clear areas are adjacent (open position), there is viewing through the window. When the printed area of one panel is aligned over the clear area of the second panel, vision through the shutter (closed position) is blocked. When the shutter is in the “open” position, the clear areas on both shutter panels are aligned. When the shutter is in the closed position, the printed areas on the second shutter panel are moved to be adjacent to the clear areas on the first shutter panel blocking vision through the shutter.

### BRIEF DESCRIPTIONS OF THE DRAWINGS

FIG. 1 shows an arched shutter;

FIG. 2a is a side view of the shutter of FIG. 1 showing a moveable outer panel;

FIG. 2b is another side view of the shutter of FIG. 1 showing a moveable inner panel;

FIG. 3 shows a rectangular shutter;

FIG. 4 is a top view of FIG. 3 showing a moveable inner panel;

FIG. 5 is a top view showing a variation of the shutter FIG. 3 showing a moveable outer panel;

FIG. 6 shows a digitized shutter assemble in the open position;

FIG. 7 shows a digitized image shutter assembly in the closed position.

FIG. 8 shows the stationary panel of the shutter of FIGS. 6 and 7;

FIG. 9 shows the movable panel of the shutter of FIGS. 6 and 7 rotated to the closed position;

FIG. 10 shows the movable panel of a digitized rectangular shutter.

FIG. 11 shows the stationary panel of a digitized rectangular shutter.

FIG. 12 shows a rectangular shutter with movable panel in closed position.

FIG. 13 shows a rectangular shutter in an open position with aligned printed panels, allowing viewing through clear areas of panels, and shows how a new (merged) image is created when translucent printed panels are aligned.

### DESCRIPTION OF A PREFERRED EMBODIMENT

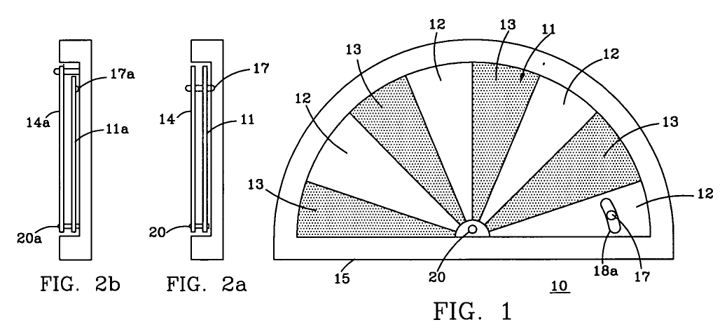

FIG. 1 shows a shutter 10 that can be mounted in a circular window frame 15. Shutter 10 has two panels, one panel 11 is in a fixed position and the second panel 14 is moveable. Either panel may be in a fixed position and the other can be moveable. Each panel is semicircular shaped with alternate pie-shaped clear and printed regions. Regions 12, for example, are clear. Shutter panel 11 may be made of glass or clear plastic material such as Lexan®) or plexiglass. The printed regions 13 may be made opaque or translucent, for example, by digitized images. Post 17 extends outward from shutter panel 14 through a opening 18a in panel 11. Post 17 is used to rotate panel 14 to open or close the shutter. When open, each of the clear regions of each panel are adjacent or over each other allowing viewing through the clear panels. When closed, the printed regions 13 are aligned to the clear regions 12, blocking viewing though the shutter. Panel 14 rotates about pin 20.

FIG. 2a is a side view of shutter 10 with a moveable outer panel. Panels 11 and 14 are shown spaced apart, with pin 17 attached to panel 14 and extending through the opening 18a, shown in FIG. 1. Pin 20 holds panels 11 and 14 in a spaced relationship and allows panel 11 to rotate to open and close the shutter.

FIG. 2b is a side view of shutter 10 shows a moveable inner panel. Panels 11a and 14a are shown spaced apart. Pin 20a holds panels 11a and 14a in a spaced relationship and allows panel 11 to rotate to open and close the shutter. Button 17a is used to move panel 11a.

Both shutters, as illustrated in FIGS. 2a and 2b are viewed from the right side.

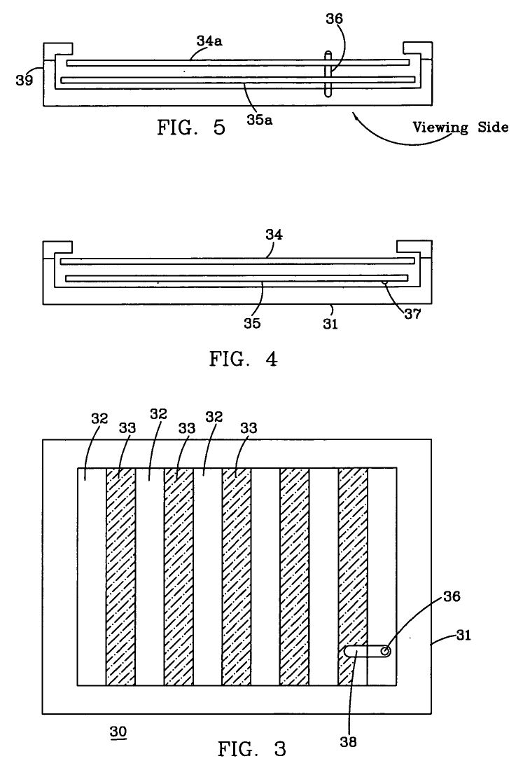

FIGS. 3 and 4 show a rectangular shutter 30 mounted in frame 31 with two panels 34 and 35. Each panel has alternate regions that are clear 32 and opaque or translucent 33. For example, panel 34 has alternate regions 32 and 33. As illustrated in FIG. 4 panel 34 is mounted in frame 31. Panel 35 is moveably mounted in frame 31. Pin or button 37, attached to panel 35, is used to move panel 35 either right or left to move clear regions on panels 34 and 35 adjacent to each other to allow viewing though shutter 30, and to move the opaque/digitized regions of panel 35 adjacent to a clear region of panel 34 to close viewing though the shutter. FIG. 5 shows a modification, providing a slot 38 (FIG. 3) through stationary panel 35a in which panel 34a may be moved by moving pin 36. In either configuration, one panel may be fixed and the other one moveable to open and closed the shutter.

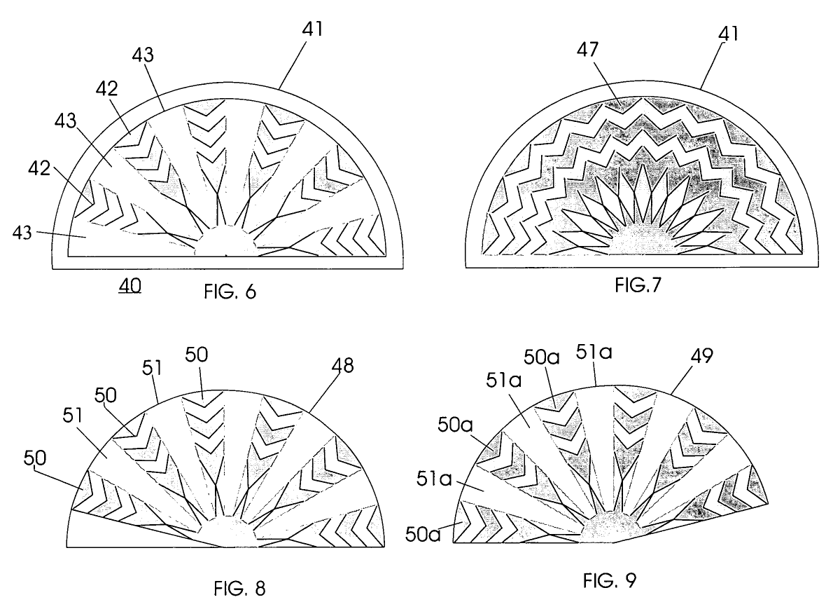

An example of the digitized image which may be altered by opening and closing a shutter is shown in FIGS. 6-9. In FIG. 6, shutter 40, in frame 41, is in the open position so that the clear regions of each panel are aligned with each other and the opaque regions with a digitized image are aligned with each other. The panels have clear regions 43 and digitized image regions 42. The individual panels are illustrated in FIGS. 8 and 9, described below.

In the closed position, FIG. 7, the clear regions of one panel are aligned with the opaque regions of the other panel. As seen in FIG. 6, with the shutter open one pattern is shown and as viewed in FIG. 7, when the shutter is closed, a different pattern is shown. The pattern illustrated is shown by way of example only, and various patterns may be used to illustrate one pattern when the shutter is open and another pattern when the shutter is closed.

FIG. 8 shows single panel 48 as it would be positioned in the frame 41 and in a stationary non-rotating position. FIG. 9 shows panel 49. It is shorter on one side allowing it to rotate on post 20. It has digital images 50a and clear areas 51a. When panel 49 is aligned with stationary panel 48, panel 49 can be rotated on post 20, allowing it to be moved to the open position, FIG. 6, or to a closed position, FIG. 7.

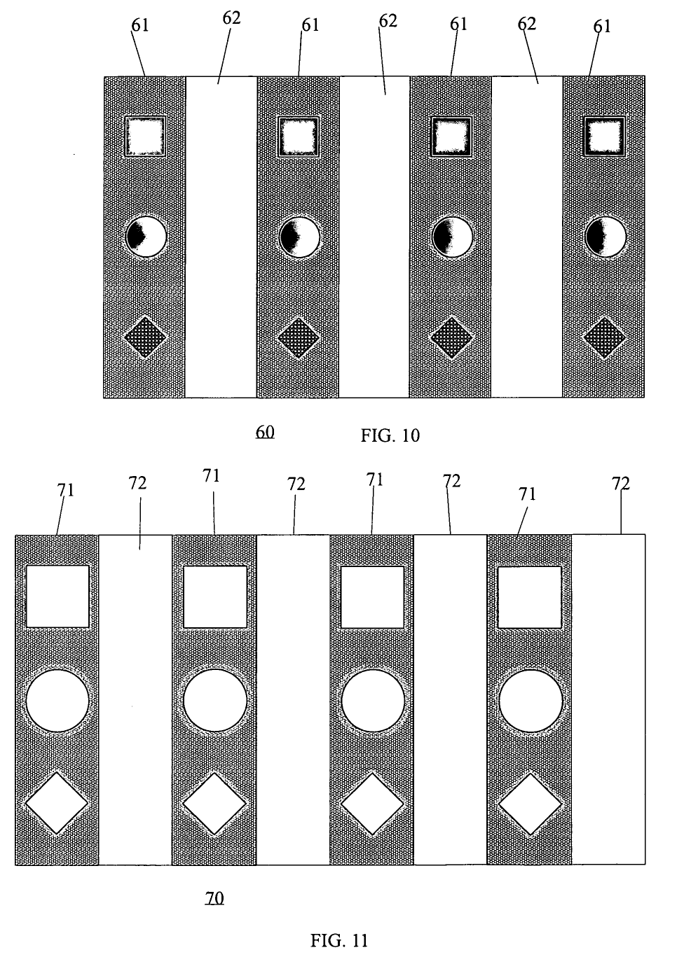

FIG. 10 shows the movable panel 60 of a rectangular shutter. It has alternating painted 61 and clear sections 62. It is shorter than stationary panel 70 (FIG. 11), allowing it to move to an open or closed position in relation to panel 11.

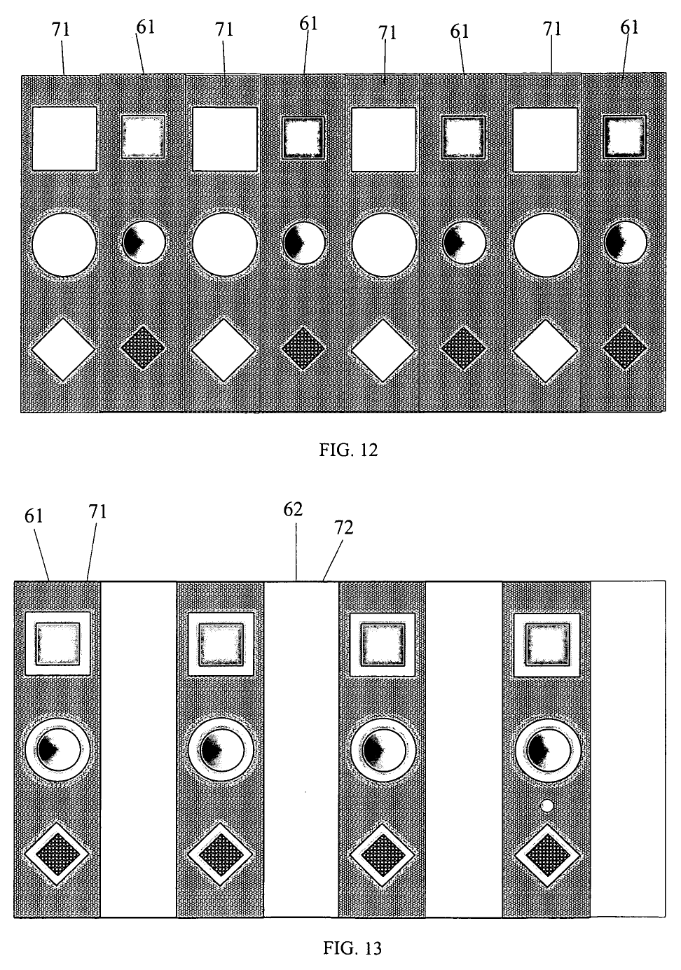

FIG. 11 shows the stationary panel 70 of a rectangular shutter. Panel is used in conjunction with panel 60 to form the rectangular shutter shown in FIG. 12. FIG. 12 shows panels 60 and 70 aligned in the closed position. Each opaque or translucent panel is aligned over the clear regions of the other panel.

FIG. 13 shows panels 60 and 70 aligned in the open position. Since panel regions 61 and 71 are translucent, they merge when adjacent showing a combination of the two designs of regions 61 and 71.

In practice, the opaque regions 61 and 71 may be digitized pictures or patterns so that when closed the shutter displays a complete picture or pattern, and when in the open position shows a modified picture or pattern.

What is claimed:

1. A window shutter assembly, comprising:
two panels, each panel having clear and printed areas, the printed areas having at least one digitized image thereon;
means for moving at least one of the panels with respect to other in order to align areas of the panels in a first position allow viewing through the shutter, and in a second position to prevent viewing through the shutter,
wherein when the printed areas of one panel are adjacent to the clear areas of the other panel a digitize image is displayed blocking viewing through the shutter, and when the clear areas of each panel are adjacent a second image is displayed, allowing viewing through the shutter.

2. The window shutter assembly according to claim 1, wherein the printed areas are at least one of opaque and translucent.

3. The window shutter assembly according to claim 1, wherein the printed areas of the first and second panels are at least one of a painted, silk-screened, and digitized ink area.

4. The window shutter assembly according to claim 1, where in the first and second panels are one of semicircular and circular in shape.

5. The window shutter assembly according to claim 1, wherein the first and second panels are rectangular in shape.

6. The window shutter assembly according to claim 1, including at least one of following types of image configurations; a geometric in which when the shutter is closed, a geometric shape is displayed, and when open, one half of the geometric shape is displayed; and a scene/design in which when closed, a design or scene is displayed and when open, a pattern mix of colors/designs is displayed.

7. The shutter assembly according to claim 6, in which the scene/design includes at least one of the following, swirls, forest scenes, flowers, and pictures.

8. The shutter according to claim 1, including patterns on the two panels, and the patterns on one panel mirrors the pattern on the other panel.

9. The shutter according to claim 8, wherein when the shutter is closed, two different patterns are displayed, and when open the two patterns overlay each other.

10. The shutter according to claim 3,wherein images are produced using translucent inks.

11. The shutter according to claim 1, wherein each pane is printed with a different image, and when closed, one view is radiated via natural or artificial light, and when open a different view is created, the different images merge and radiate on top of each other as the shutter is opened and closed.

12. A window shutter assembly, comprising:
two panels, each panel having clear and printed areas, the printed areas are at least one of opaque and translucent, and have at least one digitized image thereon;
means for moving at least one of the panels with respect to other in order to align areas of the panels in a first position allow viewing through the shutter, and in a second position to prevent viewing through the shutter,
wherein when the printed areas of one panel are adjacent to the clear areas of the other panel a digitize image is displayed blocking viewing through the shutter, and when the clear areas of each panel are adjacent a second image is displayed, allowing viewing through the shutter, wherein the printed areas are at least one of opaque or translucent.
